(19) United States
(12) Patent Application Publication
(10) Pub. No.: US 2025/0298953 A1
(43) Pub. Date: Sep. 25, 2025

(54) RUN-TIME MODIFICATION OF A FIELD PROGRAMMABLE GATE ARRAY OR A COARSE GRAINED RECONFIGURABLE ARRAY TO DUPLICATE THE MOST VULNERABLE FUNCTIONAL CIRCUITS BEHAVIOUR

(71) Applicant: Arm Limited, Cambridge (GB)

(72) Inventors: Mbou Eyole, Soham (GB); Balaji Venu, Bangalore (IN); Frederic Claude Marie Piry, Cagnes-sur-Mer (FR)

(73) Assignee: Arm Limited, Cambridge (GB)

(21) Appl. No.: 18/863,873

(22) PCT Filed: Mar. 3, 2023
(86) PCT No.: PCT/GB2023/050504

§ 371 Date: Nov. 7, 2024

(30) Foreign Application Priority Data
May 13, 2022 (EP) 22305712.6

(51) Int. Cl. G06F 30/347

(52) U.S. Cl. CPC G06F 30/347

(57) ABSTRACT

A data processing apparatus is provided. Determination circuitry performs a determination of a vulnerability of each of a plurality of functional circuits in a processing circuit and modification circuitry modifies a behaviour of a reprogrammable circuit to match an architectural behaviour of a vulnerable functional circuit in the functional circuits in response to the determination.

### TECHNICAL FIELD

The present disclosure relates to data processing and particularly the resilience of data processing circuits.

### DESCRIPTION

In safety-critical systems, it is important for functional circuits of the processing circuitry to be resilient to errors and therefore reliable. Such errors could be transient errors such as a bit-flip occurring from a particle strike, or could be more permanent design errors that could be exploited by an attacker. It may be tempting to build resilience by duplicating the processing circuitry, running the same software on each processing circuitry, and then arbitrating between the results of operations performed each of two, or even three different processing circuitries. However, this requires considerable circuit space and power consumption. Furthermore, it does not help against permanent design errors, which may duplicated in each processing circuitry.

### SUMMARY

Viewed from a first example configuration, there is provided a data processing apparatus comprising: determination circuitry configured to perform a determination of a vulnerability of each of a plurality of functional circuits in a processing circuit; and modification circuitry configured to modify a behaviour of a reprogrammable circuit to match an architectural behaviour of a vulnerable functional circuit in the functional circuits in response to the determination.

Viewed from a second example configuration, there is provided a data processing method comprising: performing a determination of a vulnerability of each of a plurality of functional circuits in a processing circuit; and modifying a behaviour of a reprogrammable circuit to match an architectural behaviour of a vulnerable functional circuit in the functional circuits in response to the determination.

Viewed from a third example configuration, there is provided a computer program for controlling a host data processing apparatus to provide an instruction execution environment comprising: determination logic configured to perform a determination of a vulnerability of each of a plurality of functional circuits in a processing circuit; and modification logic configured to modify a behaviour of reprogrammable logic to match an architectural behaviour of a vulnerable functional circuit in the functional circuits in response to the determination.

### BRIEF DESCRIPTION OF THE DRAWINGS

The present invention will be described further, by way of example only, with reference to embodiments thereof as illustrated in the accompanying drawings, in which:

FIG. 1 illustrates a system comprising an apparatus according to some examples;

FIG. 2 illustrates an example of different functional units and their vulnerabilities according to one example;

FIG. 3 illustrates how the vulnerability of a functional circuit can change over time;

FIG. 4 gives an example of the changing assessment with regards to vulnerability;

FIG. 5 illustrates an example in which any number of the individual functional circuits can have their architectural behaviour copied by the reprogrammable circuitry;

FIG. 6 illustrates example behaviour of the arbitration circuitry in arbitrating between results produced from the reprogrammable circuitry and the CPU; and

FIG. 7 illustrates a simulator implementation that may be used.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: determination circuitry configured to perform a determination of a vulnerability of each of a plurality of functional circuits in a processing circuit; and modification circuitry configured to modify a behaviour of a reprogrammable circuit to match an architectural behaviour of a vulnerable functional circuit in the functional circuits in response to the determination.

The above embodiment makes use of reprogrammable circuitry in order to replicate the architectural behaviour (but not necessarily other behaviours) of a functional circuit in the processing circuitry that is determined to be vulnerable. A functional circuit can be considered to be an element of the processing circuitry that performs a specific function. For instance, this might be an integer unit, a floating-point unit, a load/store unit, and so on. In replicating the architectural behaviour, the modification circuitry causes the reprogrammable circuit to behave in a manner that is consistent with the requirements of the vulnerable functional circuit. That is, the input-to-output mapping will be the same for both circuits. However, other behaviour (e.g. the specific way in which outputs are produced for particular inputs) may be different. Since a specific functional circuit's functionality is reproduced, energy is saved as compared to a situation where the entire processing circuitry is duplicated (possibly many times). This is helpful when, for instance, not every part of the processing circuitry may be vulnerable simultaneously. This depends not only on the natural vulnerability of the circuits, but also the actual instructions being executed at a particular moment in time. For instance, if the instructions being executed at a particular moment in time are mostly integer instructions then the vulnerability of a floating-point processor is likely to be low. As another example, if all the instructions being executed at a particular moment in time are integer instructions then the vulnerability may still not be low if, for instance, the natural vulnerability of the circuits used for integer operations is low (e.g. if there are few flops/transistors etc.). Since only the architectural behaviour is copied, design errors in the vulnerable functional circuit can be avoided. Still furthermore, since the behaviour of the reprogrammable circuit is modified programmatically, the exact behaviour can be changed after the processing circuitry has been fabricated. Thus, design errors that become apparent after fabrication can be resolved and it is possible to both detect and recover from errors. Vulnerability can be measured in a variety of ways. However, one way of measuring this is by the architectural vulnerability factor (AVF). This measurement represents the probability that a fault in a structure of a circuit will be visible within the program being executed. This not only takes into account the above considerations regarding vulnerability but also recognises the fact that not every error that occurs will necessarily result in an observable fault at the program level. For instance, an error that occurs in prefetching will simply result in the wrong data being prefetched. This does not, however, necessarily result in any observable problem in the underlying program. Similarly in the case of a branch predictor. Although such a fault might result in inefficient computation, it is not necessarily detectable. AVF (and other measurements of vulnerability) can be performed offline or can be determined ‘live’.

In some examples, the data processing apparatus comprises arbitration circuitry configured to arbitrate between results of the vulnerable functional circuit and between the reprogrammable circuit that matches the architectural behaviour of the vulnerable functional circuit. The arbitration circuitry determines how to reconcile the vulnerable functional circuit with the reprogrammable circuit whose behaviour has been reprogrammed to architecturally behave in the same way as the vulnerable functional circuit. There are a number of ways in which this can be done.

In some examples, in a cross-checking mode, the arbitration circuitry is configured to compare a result of the reprogrammable circuit that matches the architectural behaviour of the vulnerable functional circuit with a result of the vulnerable functional circuit and to perform an error action in response to a mismatch. In these examples, both the vulnerable functional circuit and the reprogrammable circuit that is reprogrammed to match the architectural behaviour of the vulnerable circuit are used to perform particular operations. The results are then compared with each other. If the results match, then the result is permitted to continue. Otherwise, an error action occurs. In some examples, some element of pre-emption may be permitted. That is to say that it could be assumed that the operation is performed correctly by the vulnerable functional circuit. Once the result from the reprogrammable circuit is available (which could occur at a later time), any mismatch in the results would cause an error to occur.

In some examples, the error action comprises activating a substitution mode in which a result of the reprogrammable circuit that matches the architectural behaviour of the vulnerable functional circuit is used in place of a result of the vulnerable functional circuit. Having determined that there is a mismatch between the result produced by the vulnerable functional circuit and the reprogrammable circuit that is reprogrammed to match the architectural behaviour of the vulnerable functional circuit, the reprogrammable circuit effectively ‘replaces’ the vulnerable functional circuit—whose architectural behaviour has been shown to be potentially unreliable.

In some examples, the error action comprises raising an exception. In this way, particular behaviour can be programmed into the software to handle in the most appropriate manner given the software being executed. This also makes it possible to, for instance, alert a user.

In some examples, the reprogrammable circuit that matches the architectural behaviour of the vulnerable functional circuit has different micro-architectural behaviour to the vulnerable functional circuit. Micro-architectural behaviour can be considered to include implementation detail regarding how, precisely, the architectural behaviour is achieved. This can include optimisations and improvements to the operation of the system that do not affect the overall result produced for a particular input. An example of a micro-architectural improvement could be in a multiplication circuit where the detection of an input parameter of ‘0’ immediately causes a result of ‘0’ to be output (since any multiplication by 0 is 0). This optimisation can improve the speed at which particular multiplications are performed (specifically multiplications by zero). However, the architectural behaviour remains the same (the multiplication is still correct—it is simply performed in a different manner). Thus, in these embodiments, the vulnerable circuit might have the optimisation present whereas the reprogrammable circuit might have this micro-architectural improvement removed. The architectural behaviour of both devices will therefore remain the same, but the micro-architectural behaviour is different.

In some examples, the modification circuitry is configured to modify the architectural behaviour of the reprogrammable circuit dynamically at runtime. The reprogrammable circuit can therefore be changed to match the architectural behaviour of one functional circuit at one particular time and to match the architectural behaviour of another functional circuit at a different time—while the data processing apparatus is in active use.

In some examples, the determination circuitry comprises storage circuitry to store heuristic data and the determination of the vulnerability is made using the heuristic data. The heuristic data could be derived, for instance, via offline analysis of either specific programs or a wide range of different programs, and can be used to indicate circumstances in which a particular circuit is likely to become vulnerable.

In some examples, the heuristic data comprises instruction sequences that increase a vulnerability of at least some of the functional circuits. An offline heuristical analysis could indicate that certain sequences or combinations of instructions lead to an increased vulnerability of functional circuits. For instance, this could arise due to certain code sequences necessitating the activation of certain sub-circuits within functional circuits that cause vulnerability to increase because as more sub-circuits are activated, the number of transistors and flops being used increases. This increase leads to a greater number of attack vectors being available and the increased number of transistors and flops means that more transistors/flops become susceptible to errors due to transient inadvertent bit transitions. Another possibility is that a particular code sequence could have been determined as being a possible attack vector by a malicious third party. A still further possibility is that a particular code sequence leads to slightly riskier behaviour taking place—for instance, the use of data speculation might be required for certain code sequences. Architecturally, incorrect data speculation should eventually be eliminated. However, the fact that incorrect data values may be used for a brief period could be said to increase the vulnerability of functional circuits. The heuristic data could therefore indicate that, for instance, the instruction sequence SUB, ADD, MUL leads to increased vulnerability. This sequence can therefore be detected at a decoder and the determination circuitry can be informed of the consequential increase.

In some examples, the data processing apparatus comprises: compression circuitry to compress one or more signals of the vulnerable functional circuit to produce one or more compressed signals; and decompression circuitry to decompress the one or more compressed signals and to provide one or more decompressed signals to the reprogrammable circuit that matches the architectural behaviour of the vulnerable functional circuit. The reprogrammable circuit can therefore be made to operate on the same signals provided to the vulnerable functional circuit even though the extent of those signals (the number of bits to be transferred) is large.

In some examples, the one or more signals of the vulnerable functional circuit are signals produced internally to the processing circuitry. Typically, due to the internal bandwidth of the processing circuitry being very high, the signals between functional circuits can be extensive. Consequently, in order to emulate or replicate the behaviour of a vulnerable functional circuit, it can be necessary to duplicate a large quantity of the signals provided to that vulnerable functional circuit. This differs from a situation in which the processing circuitry itself is replicated. In this situation, only the interface signals to the processing circuitry (which are typically smaller) need to be replicated. Since, in these examples, the signals are intensive, the provision of compression and decompression circuitry can be used to lessen the bandwidth requirements.

In some examples, the reprogrammable circuit is a field programmable gate array or a coarse grained reconfigurable array. Other types of reprogrammable computational circuits or general purpose processors can be provided, which enables the exact functionality of that circuit to be controlled and/or changed at runtime—thereby enabling the system to arbitrarily change which of the functional circuits is duplicated. The reprogrammable circuit may therefore not have one single function, but may have many possible functions.

In some examples, the modification circuitry is configured to modify the behaviour of the reprogrammable circuit to match a plurality of architectural behaviours of vulnerable functional circuits in the functional circuits in response to the determination. The reprogrammable circuit can therefore be capable of simultaneously replicating several functional circuits specifically when those functional circuits have been deemed to be vulnerable.

In some examples, the vulnerable functional circuits make up at most a subset of the functional circuits. That is, the reprogrammable circuit is not used to architecturally replicate the entire functionality of the processing circuit, but instead architecturally replicates only a proportion of the circuit depending on those circuits that are deemed to be most vulnerable at a particular moment in time.

In some examples, in response to the determination circuitry determining that multiple of the plurality of functional circuits are vulnerable, the modification circuitry is configured to modify those of the functional circuits that are determined to be most vulnerable. This could be by ‘synthesising’ the behaviour of all of the functional circuits whose vulnerability is over a threshold or by ‘synthesising’ the behaviour of the top x most vulnerable functional circuits.

Particular embodiments will now be described with reference to the figures.

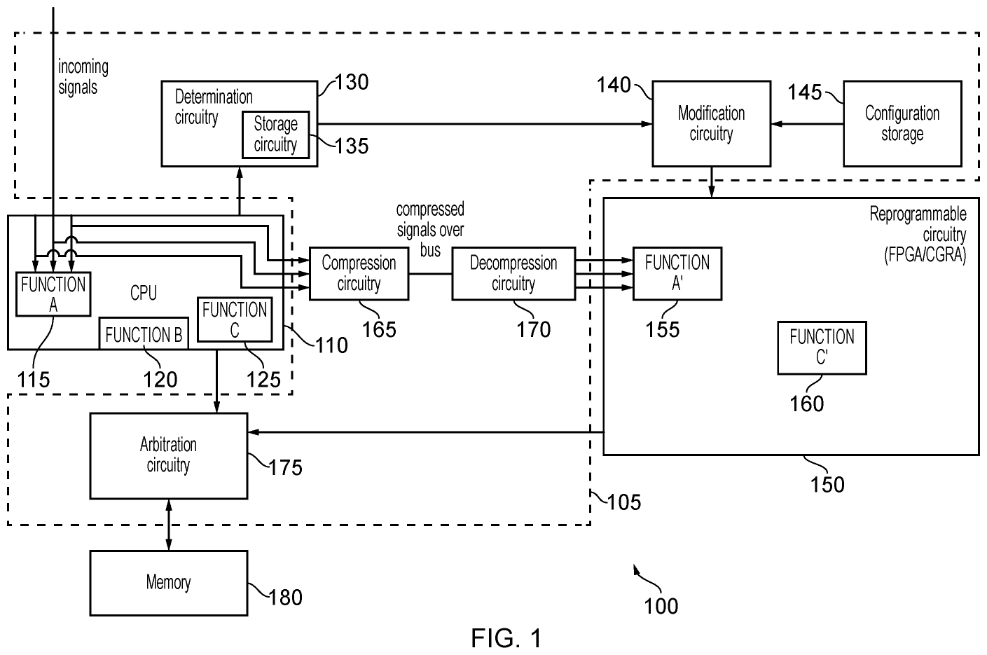

FIG. 1 illustrates a system 100 comprising an apparatus 105 according to some examples, reprogrammable circuitry 150 used by that apparatus 105, a CPU 110, and memory (which could be a cache, a DRAM-backed memory, another type of memory, or a hierarchy or hybrid system comprising several such storage circuits). The processing circuitry contains a number of functional circuits 115, 120, 125. Each of these functional circuits may be response for performing distinct operations within the CPU 110. For instance, one of the functional circuitry 115 might perform integer operations while another 120 might be responsible for memory operations. While operating, determination circuitry 130 in the apparatus 105 might determine that one or more of these functional circuits 115, 120, 125 is vulnerable. In particular, the determination circuitry 130 might determine that there is a potential for an error to occur that is visible to the underlying program executing using the CPU 110. This determination can be made using heuristic data stored in storage circuitry 135. The heuristic data can contain, for instance, details about the number of flops or transistors in each functional circuit 115, 120, 125 of the CPU 110 and/or details about particular sequences of instructions, behaviours, parameters (or combinations of parameters) etc. that are known to render or are likely to increase the probability with which a functional circuit 115, 120, 125 becomes vulnerable. If and when it is determined that a functional circuit 115, 120, 125 is presently considered to be vulnerable, modification circuitry 140 is instructed to modify reprogrammable circuitry 150 to adopt the same architectural behaviour of the vulnerable circuit. This can be achieved using configuration data 145 stored within configuration storage 145 that stores hardware description language (HDL) files for versions of the functional circuits 115, 120, 125.

In this example, the reprogrammable circuitry 150 is shown to have architectural equivalents 155, 160 of two 115, 125 of the functional circuits. Such “replicas” are architecturally the same in the sense that for a given set of input signals, these “replicas” will produce the same outputs. However, the manner in which those outputs are produced and in particular, optimisations that might be performed in the functional circuitry 115, 125 might not be performed (which is to say that micro-architecturally, there may be a difference).

Arbitration circuitry is provided to arbitrate between results produced by the CPU 110 and the “replicas” within the reprogrammable circuitry 150. There are a number of ways in which this arbitration might be performed, as will be discussed in more detail below. The result of the arbitration can, for instance, be written to (or result in reading from) a memory system 180.

Further (optional) functionality of the apparatus 105 shown in FIG. 1 is the presence of compression circuitry 165 and decompression circuitry 170. Since the apparatus 105 modifies the reprogrammable circuitry 150 to architecturally correspond with the behaviour of the individual functional circuits 115, 120, 125 of the processing circuitry, it is possible that it will be necessary for signal inputs to individual functional circuits 115, 120, 125 to be provided to parts of the reprogrammable circuitry 155, 160. However, the width of data buses within the CPU 110 tend to be very large in comparison to the width of the data bus on which the CPU 110 and reprogrammable circuitry 150 lie. Hence, while this bus might be sufficient if the CPU 110 were to be replicated wholescale, it may (in some situations) ironically be insufficient for supporting the replication of the architectural behaviour of individual functional circuits 115, 125. Consequently, compression circuitry 165 and decompression circuitry 170 are provided so that the signals that would be internal to the CPU 110 can be compressed when being passed along a narrow width bus to the reprogrammable circuitry 150.

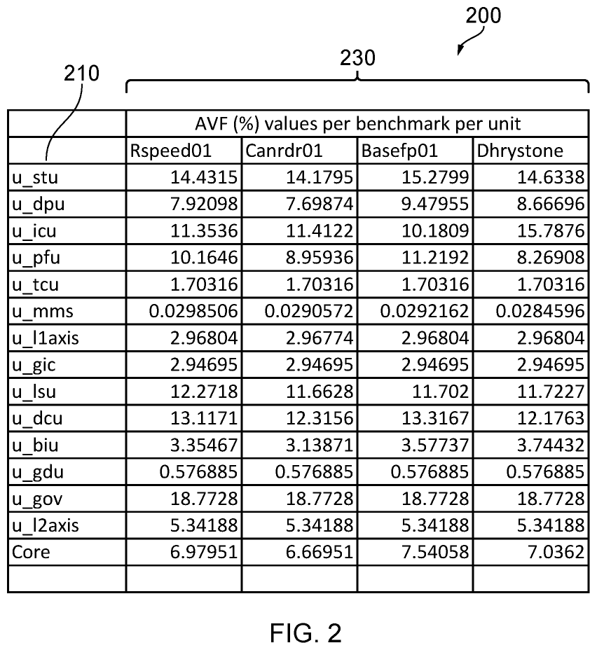

FIG. 2 is of a table 200 that illustrates an example of different functional units 210 and the architectural vulnerability factor (AVF), which is one particular way of characterising the probability that a fault in a structure (e.g. a flop) of that functional circuit will lead to an error that is visible at the application level. A higher score therefore indicates a more vulnerable circuit. It will be appreciated that the number of flops in each structure can provide an indication of the vulnerability of the functional circuit. FIG. 2 illustrates a number of different AVF values 230 for different components in a CPU design while executing different benchmarks.

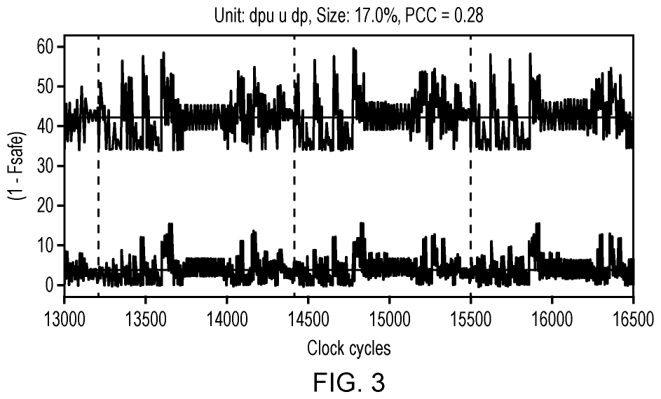

FIG. 3 illustrates how, for a given processing circuit, the vulnerability of a particular functional circuit can differ over time. The graph of FIG. 3 has been generated according to the techniques described in U.S. Pat. No. 10,747,601 (the contents of which are incorporated herein), which describes how formal methods rather than fault injection experiments can be used in order to express reliability. In short, these techniques look at a series of instructions and firstly determine the contribution of each of a set of circuit blocks according to how often each of those circuit blocks is used in executing that series of instructions. Then, it is possible to determine a failure mode for each instruction by considering the failure rate of each block used by that instruction divided by the total number of circuit blocks used by each of the instructions in the series of instructions. So if each of three instructions in the series of instructions use two blocks, a total of six circuit blocks are used. If an ADD instruction uses an issue block and an add block and if the failure rate of an ADD instruction is 0.8 for an issue block and 0.2 for an add block, then the failure mode (vulnerability) for an ADD instruction in the series of instructions is (0.8+0.2)/6.

In particular, FIG. 3 shows how the data processing unit's vulnerability (expressed as 1—Fsafe, which is approximately the same as AVF) changes over a number of clock cycles, depending on whether the vulnerability is estimated according to a more conservative approach or a less conservative approach. FIG. 3 therefore serves to show that the current vulnerability of a given circuit depends not only on the nature of that circuit but also the actual code being executed.

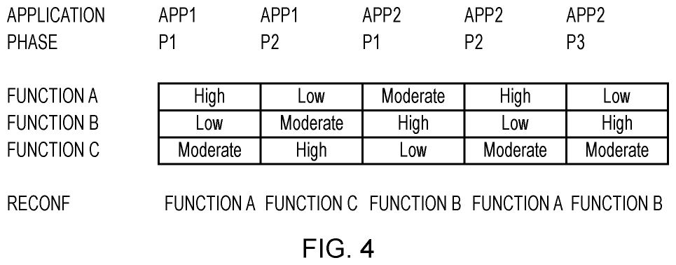

FIG. 4 gives an example of the changing assessment with regards to vulnerability. In this example, two applications (APP1 and APP2) execute. Each application has a number of phases (P1 and P2 in the case of APP1 and P1, P2, and P3 in the case of APP2). This example assumes that there are three functional circuits (FUNCTION A, FUNCTION B, FUNCTION C) and that the reprogrammable circuitry 150 is able to replicate the architectural functionality of exactly one of these circuits. In a first phase of a first application, functional circuit A is considered to be highly vulnerable, functional circuit C is considered to be moderately vulnerable, and functional circuit B is considered to have low vulnerability. Consequently, functional circuit A is selected to have its architectural behaviour copied in the reprogrammable circuitry 150. In a second phase of a first application, functional circuit C is considered to be highly vulnerable, functional circuit B is considered to be of moderate vulnerability, and functional circuit A is considered to be of low vulnerability. Consequently, the reprogrammable circuitry 150 is reprogrammed to copy the architectural behaviour of functional circuit C. In a first phase of the second application, functional circuit B is high vulnerability, functional circuit A is moderate vulnerability and functional circuit C is low vulnerability, leading to replication of the architectural behaviour of functional circuit B. Then in the second phase of the second application, functional circuit A becomes the highest vulnerability and in the third phase of the second application, functional circuit B becomes the highest vulnerability leading to the architectural replication of functional circuitry A and B, respectively, in the second the third phases of the second application.

Of course, in other examples, the reprogrammable circuitry 150 may be able to replicate the architectural behaviour of two of the functional circuits, in which case the high vulnerability circuit and medium vulnerability circuit could have their architectural behaviour duplicated.

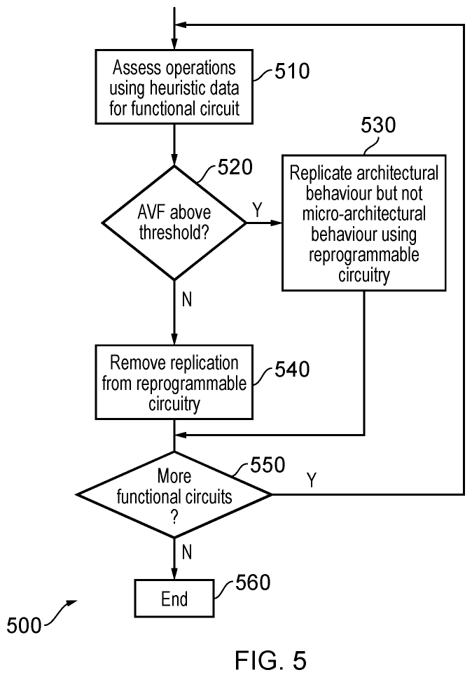

FIG. 5 illustrates an example in which any number of the individual functional circuits can have their architectural behaviour copied by the reprogrammable circuitry. In the flowchart 500, at a step 510, the operations being performed in respect of a given functional circuit are considered. This can be achieved by calculating, for instance, the AVF for that component at the present moment in the runtime of the system. Although this value is calculated at runtime (since the instructions being executed and therefore the vulnerability will vary over the runtime of the application), it may make use of heuristic or structural data that can be determined offline. For instance, the heuristic data might consider the underlying vulnerability (e.g. the number of flops) in each functional circuit. The heuristic data could alternatively or additionally consider particular sequences of instructions or behaviours that alter the vulnerability profile. This might not only include, for instance, the recognition that code sequences that don't use a vulnerable circuit essentially render that circuit low vulnerability, but might also include code sequences that are known to be problematic or that represent (for instance) known attack vectors for a malicious third party. In any event, all of these factors are combined to produce a vulnerability score. At step 520, the vulnerability score (AVF in this example) is compared to a threshold and if the threshold is exceeded then at step 530, that architectural behaviour of that circuit (but not its micro-architectural behaviour) is replicated by reprogramming the reprogrammable circuitry. The process then proceeds to step 550. If the threshold is not exceeded, then at step 540, the replicated behaviour is removed from the reprogrammable circuitry (if present) and the process continues to step 550. At step 550, it is determined whether there are more functional circuits to consider. If so, the process returns to step 510. Otherwise, the process ends at step 560 until the next assessment period.

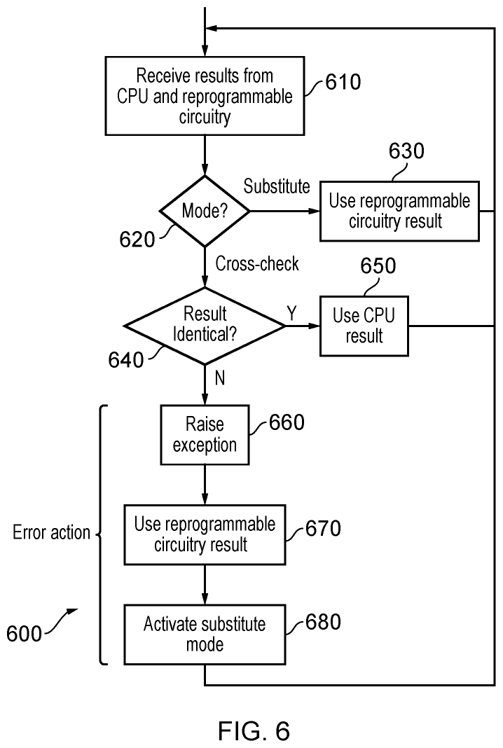

FIG. 6 illustrates example behaviour of the arbitration circuitry 175 in arbitrating between results produced from the reprogrammable circuitry 150 and the CPU 110. The example behaviour is illustrated in the form of a flowchart 600. At a step 610, the results from the CPU 110 and the reprogrammable circuitry 150 are provided to the arbitration circuitry 175. At a step 620, it is determined what mode the arbitration circuitry 175 operates in. If the mode is a substitution mode, then at step 630, the reprogrammable circuitry 150 result is used and the process returns to step 610. Otherwise, if the mode is a cross-checking mode, the arbitration circuitry compares the two results. Step 640 determines whether the results are identical or not. If so, then the CPU result is used at step 650. This is because the result is considered to be correct, and the CPU is able to take advantage of micro-architectural improvements that mean that the result has already been used, or may allow future operations to be performed more efficiently. The process then returns to step 610. If the results are not identical, then an error action occurs. In this example, the error action contains three parts. Firstly, at a step 660, an exception is raised. This allows the user (or the underlying program) to be alerted to the vulnerability. The program can thereby decide whether to take further action, depending on the nature of the operation being performed and how critical it is (for instance, tuning a radio in a car might not be considered sufficiently safety critical to bother doing anything, whereas an airbag deployment system might be considered critical such that some action must be taken). Then, at a step 670, the result of the reprogrammable circuit 150 is used. This is selected over the CPU 110 since the lack of optimisations make it more likely that the reprogrammable circuit 150 result is correct. Then, at step 680, the substitute mode is activated. This means that, until deactivated, the reprogrammable circuit 150 will continue to be used over the functional circuit in the CPU 110. Depending on any underlying policy, this process could continue indefinitely, until a firmware ‘fix’ is implemented, for a time period, until the software indicates otherwise, and so on. The process then returns to step 610.

Of course, it will be appreciated that according to an underlying policy, the substitute mode might be enabled immediately. For instance, if certain attack vectors become known such that certain functional circuits are “always” vulnerable, then the substitute mode might be permanently enabled for that functional circuit (or possibly until/unless a firmware fix can be provided).

In some embodiments, in the substitute mode, the operation of the original vulnerable functional circuit is disabled and therefore no result is produced.

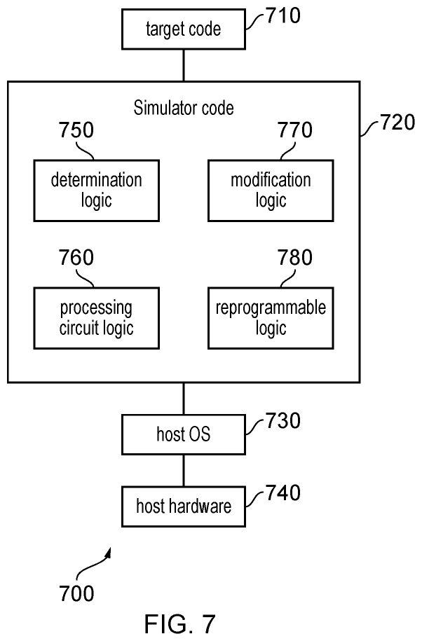

FIG. 7 illustrates a simulator implementation 700 that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 740, optionally running a host operating system 730, supporting the simulator program 720. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 740), some simulated embodiments may make use of the host hardware, where suitable.

The simulator program 720 may be stored on a computer-readable storage medium (which may be a non-transitory medium), and provides a program interface (instruction execution environment) to the target code 710 (which may include applications, operating systems and a hypervisor) which is the same as the interface of the hardware architecture being modelled by the simulator program 720. Thus, the program instructions of the target code 710 may be executed from within the instruction execution environment using the simulator program 720, so that a host computer 730 which does not actually have the hardware features of the apparatus 105 discussed above can emulate these features. In this example, the simulator code 720 includes determination logic 750 that is used for determining the vulnerability of a (simulated) functional component within processing circuit logic 760. Modification logic 770 is also provided for dynamically reprogramming reprogrammable logic 780 to perform (architecturally) the same behaviour as one or more of the functional components within the (simulated) processing circuit logic 760. This can be achieved by generative programming, or by activating particular libraries of code that are available to emulate architectural behaviours of the (simulate) processing circuit logic 760, which is the code in the simulator used to execute the target code 710.

By the above examples, it is possible to respond to the dynamic determination that a functional component or circuit of a processing circuit is vulnerable by selectively reprogramming a reprogrammable circuit to copy the architectural behaviour of the vulnerable circuit. It is therefore possible to detect and respond to changes in vulnerability with relatively low power cost and without using a large circuit space in order to provide resilience to such vulnerabilities.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus comprising:
determination circuitry configured to perform a determination of a vulnerability of each of a plurality of functional circuits in a processing circuit; and
modification circuitry configured to modify a behaviour of a reprogrammable circuit to match an architectural behaviour of a vulnerable functional circuit in the functional circuits in response to the determination.

2. The data processing apparatus according to claim 1, comprising:
arbitration circuitry configured to arbitrate between results of the vulnerable functional circuit and between the reprogrammable circuit that matches the architectural behaviour of the vulnerable functional circuit.

3. The data processing apparatus according to claim 2, wherein
in a cross-checking mode, the arbitration circuitry is configured to compare a result of the reprogrammable circuit that matches the architectural behaviour of the vulnerable functional circuit with a result of the vulnerable functional circuit and to perform an error action in response to a mismatch.

4. The data processing apparatus according to claim 3, wherein
the error action comprises activating a substitution mode in which a result of the reprogrammable circuit that matches the architectural behaviour of the vulnerable functional circuit is used in place of a result of the vulnerable functional circuit.

5. The data processing apparatus according to claim 3, wherein
the error action comprises raising an exception.

6. The data processing apparatus according to claim 3, wherein
the reprogrammable circuit that matches the architectural behaviour of the vulnerable functional circuit has different micro-architectural behaviour to the vulnerable functional circuit.

7. The data processing apparatus according to claim 1, wherein
the modification circuitry is configured to modify the architectural behaviour of the reprogrammable circuit dynamically at runtime.

8. The data processing apparatus according to claim 1, wherein
the determination circuitry comprises storage circuitry to store heuristic data and the determination of the vulnerability is made using the heuristic data.

9. The data processing apparatus according to claim 8, wherein
the heuristic data comprises instruction sequences that increase a vulnerability of at least some of the functional circuits.

10. The data processing apparatus according to claim 1, comprising:
compression circuitry to compress one or more signals of the vulnerable functional circuit to produce one or more compressed signals; and
decompression circuitry to decompress the one or more compressed signals and to provide one or more decompressed signals to the reprogrammable circuit that matches the architectural behaviour of the vulnerable functional circuit.

11. The data processing apparatus according to claim 10, wherein
the one or more signals of the vulnerable functional circuit are signals produced internally to the processing circuitry.

12. The data processing apparatus according to claim 1, wherein
the reprogrammable circuit is a field programmable gate array or a coarse grained reconfigurable array.

13. The data processing apparatus according to claim 1, wherein
the modification circuitry is configured to modify the behaviour of the reprogrammable circuit to match a plurality of architectural behaviours of vulnerable functional circuits in the functional circuits in response to the determination.

14. The data processing apparatus according to claim 13, wherein
the vulnerable functional circuits make up at most a subset of the functional circuits.

15. The data processing apparatus according to claim 1, wherein
in response to the determination circuitry determining that multiple of the plurality of functional circuits are vulnerable, the modification circuitry is configured to modify those of the functional circuits that are determined to be most vulnerable.

16. A data processing method comprising:
performing a determination of a vulnerability of each of a plurality of functional circuits in a processing circuit; and
modifying a behaviour of a reprogrammable circuit to match an architectural behaviour of a vulnerable functional circuit in the functional circuits in response to the determination.

17. A computer program for controlling a host data processing apparatus to provide an instruction execution environment comprising:
determination logic configured to perform a determination of a vulnerability of each of a plurality of functional circuits in a processing circuit; and
modification logic configured to modify a behaviour of reprogrammable logic to match an architectural behaviour of a vulnerable functional circuit in the functional circuits in response to the determination.
